(19) United States
(12) Patent Application Publication
(10) Pub. No.: US 2010/0306293 A1
(43) Pub. Date: Dec. 2, 2010

(54) Galois Field Multiplier

(75) Inventors: Yu Fei Li, Shanghai (CN); Yong Lu, Shanghai (CN); Guang Chang Ye, Shanghai (CN); Fan Zhou, Shanghai (CN)

Correspondence Address: IBM MICROELECTRONICS;INTELLECTUAL PROPERTY LAW, 1000 RIVER STREET, 972 E, ESSEX JUNCTION, VT, 05452, US

(73) Assignee: International Business Machines Corporation, Armonk, NY (US)

(21) Appl. No.: 12/778,378

(22) Filed: May 12, 2010

(30) Foreign Application Priority Data
May 31, 2009 (CN) 2009-10142713.0

(51) Int. Cl. G06F 7/44; G06F 5/01

(52) U.S. Cl. 708/209; 708/492; 708/625; 708/232

(57) ABSTRACT

A Galois field multiplier is provided, comprising a multiplication circuit for inputting two m bits binary multiplicators and outputting their product, wherein m is an integral power of 2, and the output of said multiplication circuit is consisted of a high bits portion output and a low bits portion output; a memory for storing a Galois field multiplication coefficient array calculated from a selected Galois field primitive polynomial; a first module for performing operation on the output of said multiplication circuit and the Galois field multiplication coefficient array stored in said memory to obtain the product of the two m bits binary multiplicators over Galois field. The Galois field multiplier has small hardware footprint, short response latency and strong universality.

### TECHNICAL FIELD

This invention relates to an integrated circuit design in communication area, and more particularly, to an integrated circuit design of a Galois field multiplier.

### BACKGROUND

Galois field multiplier, as a special multiplier, is also known as finite field multiplier for all of its calculations are performed over finite field. It has been widely used in various applications of communication, such as encoding, error correction, encryption, etc.

Some processors have been provided with the capability of Galois field multiplication, logic modules or traditional DSPs (digital signal processor) are also adaptable for achieving Galois field multiplication. These schemes, however, involve complicated multiplication over Galois field, take significant processing time. Due to its extensive usage, Galois field multiplier is usually implemented as a single circuit, generally, a microelectronic IC (integrated circuit) for the purpose of efficiency. With respect to IC design, it is desirable for shrinking the circuit area as small as possible for cost efficiency.

In the prior art, IC design methods of Galois field multiplier can be mainly classified into three categories: Bit-serial, digit-serial and Bit parallel.

According to Bit-serial and digit-serial methods, when inputting multiplicator and multiplicand, they are serially inputted into Galois field multiplier bit by bit, which may have the advantages of decreased hardware footprint and lower design complexity. Both of Bit-serial and digit-serial methods have O(m) logic area for GF(2^{m}) multiplication, while Bit-serial method may lead to a larger multiplication output response latency, typically m clock cycles.

Bit parallel method, on the other hand, specifies when inputting multiplicator and multiplicand, they are inputted in parallel into Galois field multiplier based on actual bit width of them, which has the advantages of smaller multiplication output response latency, merely 1 clock cycle, but along with increased hardware footprint and higher design complexity. When dealing with GF (2^{m}) multiplication, Bit parallel method needs O(m²) logic area. However, existed Bit parallel method is often optimized with specific primitive polynomials, most of which focus on trinomials, i.e., primitive polynomial, such as P(x)=x⁴+x+1, therefore lacking universality in their design.

Hence, it is needed to provide a Galois field multiplier with decreased hardware footprint, simple design, smaller response latency, as well as strong universality.

### BRIEF SUMMARY

To overcome the defections of Galois field multiplier aforementioned, this invention provides a Galois field multiplier, which has decreased hardware footprint, smaller response latency and perfect universality.

According to one aspect of this invention, a Galois field multiplier is provided, comprising: a multiplication circuit for inputting two m bits binary multiplicators and outputting their product, wherein m is an integral power of 2 and output of said multiplication circuit is consisted of a high bits portion and a low bits portion; a memory for storing a Galois field multiplication coefficient array calculated from a selected Galois field primitive polynomial; a first module for performing operation on the output of said multiplication circuit and the stored Galois field multiplication coefficient array to obtain the product of said two m bits binary multiplicators over Galois field multiplication.

### BRIEF DESCRIPTION OF SEVERAL VIEWS OF THE DRAWINGS

The aforementioned and other objects, features and advantages of this invention will be apparent from the following detailed description in conjunction with the accompanying drawings, wherein like reference numerals designate like elements, and in which:

FIG. 1 schematically illustrates a circuit of a Galois field multiplier;

FIG. 2 schematically illustrates a multiplication circuit for acquiring the product of two m bits binary multiplicators; and

FIG. 3 schematically illustrates a more detail implementation of the third module of FIG. 2.

### DETAILED DESCRIPTION

Some preferred embodiments of this invention will be described in detail with reference to the drawings of those embodiments. However, the present invention can be implemented in various ways, and should not be limited to the embodiments described herein. On the contrary, those embodiments are provided for a full and clear understanding of this invention, and as such those skilled in the art can be completely conveyed of the scope of this invention.

First, some essential knowledge about Galois field multiplication will be introduced blow for a better understanding of this invention.

Galois field GF(x) represents a group of elements on which some binary operations can be performed, and the addition and multiplication thereof must comply with the commutative law, the distribution law and the associative law.

The multiplication over Galois field can be defined as:

Mod {AB/P(x)} (1)
wherein, A and B are two multiplicators, AB indicates multiplication of the two multiplicators, P(x) is the primitive polynomial over Galois field, x is the primitive element over Galois field, and Mod is the symbol of modulo operation.

For the convenience of this description, both AB and A·B are used hereinafter to represent the traditional multiplication of two multiplicators, only Mod {AB/P(x)} represents the Galois field multiplication, and no further explanation will be given.

There are many ways in the prior art to implement Galois field multiplication, while this invention will focus on its implementation in circuit design. The benefit of circuit implementation is its high processing speed. For communication application requiring a rapid response, such as encoding, encryption, error correction, etc, circuit implementation is the only eligible choice. Assuming both A and B are m bits binary codes, and:

A=aₘ₋₁aₘ₋₂ . . . a₁a₀ aᵢε{0,1},i ε{0,1 . . . m−1} (2)

B=bₘ₋₁bₘ₋₂ . . . b₁b₀ bᵢε{0,1},i ε{0,1 . . . m−1} (3)

each of A, B may represent a permutation of bits 0 or 1, and m is an integer power of 2, which in computer field is commonly selected to be 8, 16, 32, 64, 128, 256, etc.

Following Galois field multiplication, A and B can be represented as:

$$\begin{matrix}\begin{matrix}A = {x}^{m / 2} ( {x}^{( m / 2 ) - 1} {a}_{m - 1} + Λ + {a}_{m / 2} ) + \\ ( {x}^{( m / 2 ) - 1} {a}_{( m / 2 ) - 1} + Λ + {a}_{0} ) \\ = {x}^{m / 2} {A}_{h} + {A}_{l}\end{matrix} & ( 4 ) \\ \begin{matrix}B = {x}^{m / 2} ( {x}^{( m / 2 ) - 1} {b}_{m - 1} + Λ + {b}_{m / 2} ) + \\ ( {x}^{( m / 2 ) - 1} {b}_{( m / 2 ) - 1} + Λ + {b}_{0} ) \\ = {x}^{m / 2} {B}_{h} + {B}_{l}\end{matrix} & ( 5 )\end{matrix}$$

wherein, Aₗ and Aₕ represent the low bits portion and high bits portion of A respectively, Bₗ and Bₕ represent the low bits portion and high bits portion of B, and x is the primitive element of Galois field.

In converting complex Galois field calculations into computer area, the primitive element x is set to 2 in view of the binary architecture utilized in computer systems. In doing so, the addition over Galois field is equal to the binary “XOR” operation. Therefore, in this specification all of the plus symbols represent “XOR” operation, and the Galois field multiplier described below is Galois field multiplier with x=2.

Thus, within the above equations (4) and (5), a m bits binary code can be represented as the XOR value of its low m/2 bits and its high m/2 bite left shifted by m/2 bits respectively.

It will be noted, in binary Galois field multiplier design, the inventors take advantage of the divide-and-conquer policy in software design. When resolving problems having too much data to be handled, or hard to be settled, the direct solver requires a large amount of time to be resolved, or even cannot be tackled. We often divide such a problem into several sub-questions, attempting to resolve each sub-question in an appropriate manner, thereafter, combining those resolutions to form the final answer to the whole problem by a suitable method. If any sub-question is still hard to be tackled, it can be divided into smaller sub-questions and so on, until it can be resolved successfully. The above mentioned is the basic thought of the divide-and-conquer policy.

With the basic thought of divide-and-conquer policy, when calculating Galois field multiplication Mod {AB/P(x)} it can be divided into two problems: first, calculating the value of AB, and then obtaining the result of Galois field multiplication by modulo operation depending on a selected Galois field primitive polynomial P(x).

As to the calculation of AB, given:

D₀(x)=Aₗ(x)Bₗ(x)

D₁(x)=[Aₗ(x)+Aₕ(x)][Bₗ(x)+Bₕ(x)]

D₂(x)=Aₕ(x)Bₕ(x) (6)

wherein Aₗ(x) and Aₗ(x) represent the low bits portion and the high bits portion of A respectively, and Bₗ(x) and Bₕ(x) represent the low bits portion and the high bits portion of B respectively. In this invention, Aₗ(x) is equal to Aₗ over Galois field and will not be distinguished hereinafter, as such, Aₗ(x) is equal to Aₗ over Galois field and will not be distinguished (similarly, D₀(x) and D₀, D₁(x) and D₁, D₂(x) and D₂ have the same meanings and will not be distinguished also), that is, if A is a 16 bits binary code, Aₗ(x) is the low 8 bits of A, and Aₗ(x) is the high 8 bits thereof, it is the same with B. According to equations (4), (5), (6), the following equation can be derived:

$$\begin{matrix}AB = {D}_{0} ( x ) + {x}^{m / 2} [ {D}_{1} ( x ) + {D}_{0} ( x ) + {D}_{2} ( x ) ] + {x}^{m} {D}_{2} ( x ) \\ = ( {f}_{2 m - 2} {x}^{2 m - 2} + … + {f}_{m} {x}^{m} ) + ( {f}_{m - 1} {x}^{m - 1} + … + {f}_{0} )\end{matrix} \qquad ( 7 )$$

wherein, f₂ₘ₋₁, . . . fₘ, fₘ₋₁, . . . f₀ are expanded coefficients, i.e., the value of each bit of the product AB. For example, if the product AB is 10101 in binary, it can be expressed as 1×2⁴+0×2³+1×2²+0×2¹+1×2⁰ when x=2, and thus each f₂ₘ₋₁, . . . fₘ, fₘ₋₁, . . . f₀ corresponds to the respective coefficient, i.e., the value of each bit.

The equation (7) can be proven as follow:

AB=AₗBₗ+x^{m/2}[AₕBₗ+AₗBₕ]+x^{m}AₕBₕ

D₀(x)+x^{m/2}[D₀(x)+D₁(x)+D₂(x)]+x^{m}D₂(x)=AₗBₗ+x^{m/2}[D₀(x)+D₁(x)+D₂(x)]+x^{m}AₕBₕD₀(x)+D₁(x)+D₂(x)=AₗBₗ+AₕBₕ+[AₗBₗ+AₕBₕ+AₗBₕ+AₕBₗ]=AₗBₕ+AₕBₗ

Due to AₗBₗ+AₕBₕ+AₗBₗ+AₕBₕ=0, AₗB₁+AₕBₕ+AₗB₁+AₕBₕ+0 for XOR operation, D₀(x)+x^{m/2}[D₁(x)+D₀(x)+D₂(x)]+x^{m}D₂(x)=AₗB₁+x^{m/2}[AₕBₗ+AₗBₕ]+x^{m}AₕBₕ

Equation (1) can be reformed as:

$$\begin{matrix}Mod \{ AB / P ( x ) \} = Mod \{ \frac{\begin{matrix}( {f}_{2 m - 2} {x}^{2 m - 2} + … + {f}_{m} {x}^{m} ) + \\ ( {f}_{m - 1} {x}^{m - 1} + … + {f}_{0} )\end{matrix}}{P ( x )} \} \\ = Mod \{ \begin{matrix}( {f}_{2 m - 2} \frac{{x}^{2 m - 2}}{P ( x )} + … + {f}_{m} \frac{{x}_{m}}{P ( x )} ) + \\ \frac{( {f}_{m - 1} {x}^{m - 1} + … + {f}_{0} )}{P ( x )}\end{matrix} \}\end{matrix} \qquad ( 8 )$$

Commonly, P(x) is represented as P(x)=x^{m-1}+x^{m-2}+ . . . +1, each coefficient fₘ₋₁, . . . f₀ is 0 or 1, it can be seen that fₘ₋₁x^{m-1}+ . . . +f₀≦P(x), then

$$Mod \{ \frac{{f}_{m - 1} {x}^{m - 1} + … + {f}_{0}}{P ( x )} \} = {f}_{m - 1} {x}^{m - 1} + … + {f}_{0} .$$

That is, for the potion in which coefficients having corresponding degree less than m of Galois field multiplication, the result of modulo P(x) is equal to itself.

A Galois field multiplication coefficient array F is defined as:

$${F}_{2 m - 2} = Mod \{ \frac{{x}^{2 m - 2}}{P ( x )} \} , … , {F}_{m} = Mod \{ \frac{{x}^{m}}{P ( x )} \} \qquad ( 9 )$$

Then each F can be calculated in prior based on a given primitive polynomial, as such the Galois field multiplication can be transformed to modulo operation:

Mod {AB/P(x)}=(f₂ₘ₋₂F₂ₘ₋₂+ . . . +fₘFₘ)+(fₘ₋₁x^{m-1}+ . . . +f₀ (10)

From the perspective of divide-and-conquer, it can be seen from the above analysis, the equation (7) is important and the front half of it shows a method for calculating (AB).

There are m any equations of P(x) from reference documents discussing the choice of P(x), for example, U.S. Pat. No. 6,766,345B2 (Galosis Field Multiplier System) has proposed many candidates of P(x). Further, there may be more than one primitive polynomial for a given m. A primitive polynomial for m=8 commonly found in many communication standards is P(x)=x⁸+x⁴+x³+x²+1.

Thus, the value of primitive polynomial can be derived by bring x=2 into the primitive polynomial, and thus obtaining all of the coefficients of equation (9).

According to the above analysis, in a divide-and-conquer policy, this invention first provides a circuit to calculate (AB) by using equation (7), and then a circuit to calculate Mod {AB/P(x)} by equation (10) using coefficients F derived from equation (9).

With respect to the circuit design of this invention, the bit number m of two multiplicators A and B are known, and such circuit can be adaptable to any m in theory, however, m is fixed for a particular circuit, and such circuit can not calculate Galois field multiplication for any multiplicators having a bit number larger than m.

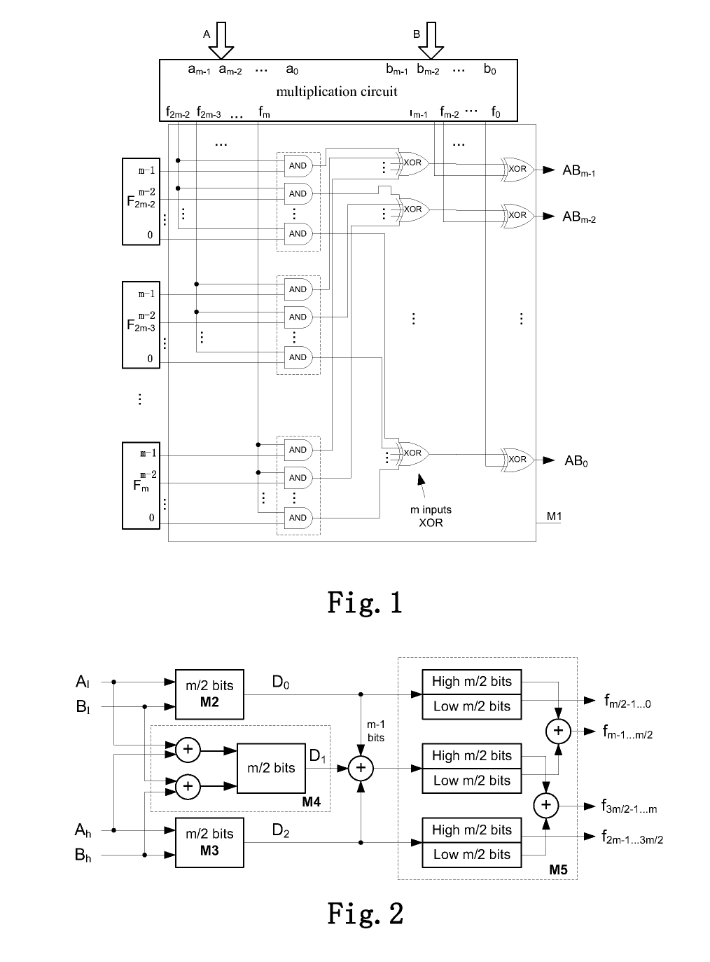

FIG. 1 schematically illustrates the circuit of a Galois field multiplier. According to FIG. 1, said Galois field multiplier comprises: a multiplication circuit for inputting two m bits binary multiplicators and outputting their product, wherein output of said multiplication circuit is consisted of a high bits portion output and a low bits portion output; a memory for storing a Galois field multiplication coefficient array calculated from a selected Galois field primitive polynomial; a first module M1 for performing operation on the output of said multiplication circuit and the Galois field multiplication coefficient array stored in said memory to obtain the product of said two m bits binary multiplicators over Galois field.

Specially, according to equation (10), the first module performs “AND” operation on each bit of the high bits portion of the output of said multiplication circuit and that of the corresponding multiplication coefficient in the Galois field multiplication coefficient array stored in said memory respectively, thereafter XOR all of the “AND” results, and then performs XOR operation on the results of above XOR and the low bits portion of output of said multiplication circuit, so as to obtain the product of the two multiplicators over Galois field.

In an implementation, said memory storing the Galois field multiplication coefficient array calculated from a selected Galois field primitive polynomial can be implemented in the form of shift register, which are able to calculate and store the Galois field multiplication coefficient array. It is also possible to calculate the Galois field multiplication coefficient array in advance and then store it in a memory array, or by any other methods of those skilled in the art. Said Galois field multiplication coefficient array comprises m-1 Galois field multiplication coefficients, each of them is m bit binary code.

In an alternative implementation, the first module may comprise a plurality of AND gates and a plurality of XOR gates, wherein the AND gates are divided into at least m-1 groups, each group having at least m AND gates and engaging in the bitwise AND operation of a coefficient in the Galois field multiplication coefficient array and the high bits portion of output of said multiplication circuit. Further, the XOR gates of the first module can be divided into two groups, each group having at least m XOR gates. Wherein each XOR gate of the first XOR group having at least m XOR gates receives the corresponding bits of output of each AND gate group as input and outputs the XOR result of corresponding bits of output of each AND gate group having at least m XOR gates; each XOR gate of the m XOR gates of the second XOR group is used to perform a XOR operation on each output of the first XOR group and a corresponding bit of the low bits portion of output of said multiplication circuit, and then output each bit of the result of Galois field multiplication. With respect to FIG. 1, each AND gate of the first AND gate group performs AND operation on each bit of the Galois field multiplication coefficient F₂ₘ₋₂ and the each bit of the high bits portion of output of the multiplication circuit, and so on for other AND gates of the first AND group. The output of the first XOR gate of the first XOR gate set is the output of the first AND gates of each AND gate group and outputs the XOR result of those corresponding bits; other XOR gates of the first XOR gate group have the similar function. The first XOR gate of the second XOR gate group receives the output of the first XOR gate of the first XOR gate group and a corresponding bit of the low bits portion of output of the multiplication circuit output as input, and outputs their XOR value; other XOR gates of the second XOR gates group have the similar function also.

Here, the output of the first XOR gates group is (f₂ₘ₋₂F₂ₘ₋₂+ . . . +fₘFₘ), the output of the second XOR gates group is (fₘ₋₁x^{m-1}+ . . . +f₀)+(f₂ₘ₋₂F₂ₘ₋₂+ . . . +fₘFₘ), wherein f₂ₘ₋₂F₂ₘ₋₂ output by the first XOR group refers to “AND” operation of f₂ₘ₋₂ and F₂ₘ₋₂.

The embodiment described above is merely a particular implementation of said first module, which as implemented in IC has a small hardware footprint, rapid response and superior universality. Certainly, those skilled in the art may understand that the first module also can be implemented in other manners, for example, in digital logics, or in DSP chipsets.

No material multiplication circuit is shown in FIG. 1, however, it is apparent for those skilled in the art that any other existed multiplication circuits can be used in this invention to achieve the same function. Here, the inventors will provide a more detail multiplication circuit for calculating the product of two multiplicators.

FIG. 2 schematically illustrates a multiplication circuit for calculating the product of two m bits binary multiplicators, i.e., said multiplication array of this invention. According to equation (7), as shown in FIG. 2, D₀(x) is defined as low bits product signal, D₁(x) is defined as bits mixed product signal, and D₂(x) is defined as high bits product signal. The multiplication circuit shown in FIG. 2 comprises a first multiplier M2, a second multiplier M3, a second module M4, a third XOR gates group and a third module M5, wherein the first multiplier receives the low bits portions Aₗ and Bₗ of two m bits binary multiplicators to be multiplied over Galois field, and outputs the low bits product signal D₀(x)=AₗBₗ; the second multiplier receives the high bits portions Aₕ, and Bₕ of the two in bits binary multiplicators to be multiplied over Galois field, and outputs the high bits product signal D₂(x)=AₕBₕ; the second module receives the low bits portions Aₗ, Bₗ, and the high bits portions Aₕ, Bₕ, of the two m bits binary omultiplicators to be multiplied over Galois field, then performs XOR operation on the low bits portions and the high bits portions of the two said multiplicators to be multiplied over Galois field respectively, and then multiplies the results of the XOR operation to output the bits mixed product D₁=[Aₗ+Bₗ][AₕBₕ]; the third XOR gates group is operable to XOR the bits mixed product signal, the low bits product signal and the high bits product signal to output a mixed XOR signal which is defined as Q=D₁(x)+D₀(x)+D₂(x). The third module is operative to receive the low bits product signal, the high bits product signal and the mixed XOR signal. It will be noted that 2^{m/2}Q can be treated as left shifting the mixed XOR signal Q by m/2 bits, similarly, 2^{m}D₂(x) means to left shift the high bits product signal D₂(x) by m bits. Thus as binary operations the third module left shifts the high bits product signal and the mixed XOR signal by m bits and m/2 bits respectively, and then performs XOR operation on the left-shifted high bits product signal (left shifted m bits), the left-shifted mixed XOR signal (left shifted m/2 bits) and the low bits product signal D₀(x) to output, i.e., the product of the two multiplicators.

In one implementation, with reference to FIG. 2, the second module M4 comprises a first XOR gate for receiving the low bits portions Aₗ, Bₗ of the two m bits binary multiplicators to be multiplied over Galois field and outputting the XOR-value thereof; a second XOR gate for receiving the high bits portions Aₕ, Bₕ, of the two m bits binary multiplicators to be multiplied over Galois field and outputting the XOR value thereof; a third multiplier for receiving the outputs of the first XOR gate and second XOR gate, and outputting the bits mixed product after a multiplication operation of those outputs.

In another implementation, the third module shown in FIG. 2 comprises two shift registers, one for left shifting the high bits product signal D₂(x) by m bits and then output the result; and the other for left shifting the bits mixed product signal by m/2 bits and then output the result; and a fourth XOR gates group for performing XOR operation on the output of the first shift register, the output of the second shift register and the output of the first multiplier, to form the output of the third module, i.e., output the product of the two multiplicators.

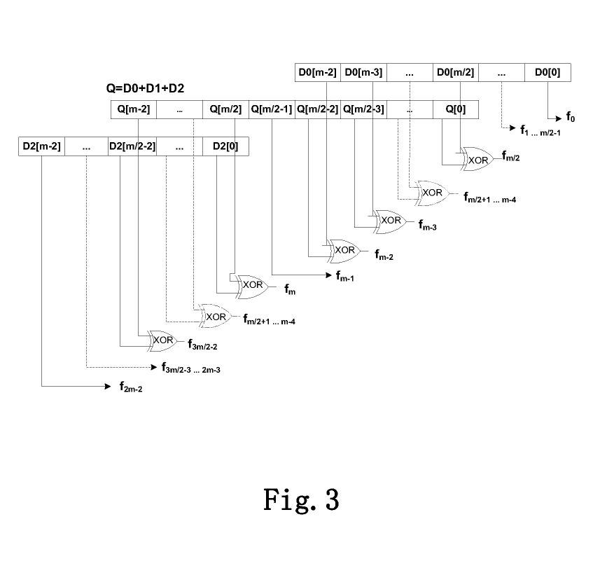

FIG. 3 schematically illustrates a more detail implementation of the third module of FIG. 2. In FIG. 3, the fourth XOR group of the third module is formed by at least m-2 XOR gates, wherein m/2-1 XOR gates are used for performing XOR operation on the high bits portion of the bits mixed XOR signal and the low bits portion of the high bits product signal; the other m/2-1 XOR gates are used for performing XOR operation on the low bits portion of the bits mixed XOR signal and the high bits portion of the low bits product signal. In particular, the output of the third module is consisted of a highest part, a higher part, a mid-part, a lower part and a lowest part, wherein except for the 1 bit mid-part, any other parts is consisted of a plurality of bits. Specially, the highest part corresponding to the m-2 to m/2-1 bits of D₂(x), the higher part corresponding to the result of bitwise AND operation on the m−2 to m/2 bits of Q and the m/2-2 to 0 bits of D₂(x), the mid-part corresponding the m/2-1 bit of Q, the lower part corresponding to the result of bitwise AND operation on the in/2-2 to 0 bits of Q and the m-2 to m/2 bits of D₀(x) and the lowest part corresponding to the m/2-1 to 0 bits of D₀ (x).

FIG. 2 and FIG. 3 merely shows a preferred circuit for calculating AB, and those skilled in the art may recognize that many other circuits can be used to calculate AB, which can be used for the Galois field multiplier of this invention.

Due to both of A and B are of m bits, the product of AB is of 2m-1 bits, and thus the output of that circuit for calculating AB has 2m-1 bits.

It can be seen from the above discuss, this invention pertains to a Bit Parallel method in nature. Through calculating and storing the coefficients associated with the primitive polynomial in advance, as compared with existed Bit Parallel methods, it is possible to reduce the response latency and shrink the area of the circuit. Also, since the primitive polynomial can be calculated in advance, any primitive polynomial can be chosen for this invention, and hence maximizing the universality of this invention.

This invention can be implemented as a general circuit, as a module of an integrated circuit, or even as a stand alone integrated circuit.

Resorting to the Cu-08 library from IBM semiconductor solutions, the inventors have implemented a 32 bits Galois field multiplier with superior performance according to this invention, which can achieve a frequency of 300 MHz easily. Table 1 below shows some performance parameters of the Galois field multiplier and its multiplication array of the invention.

It can be seen from table 1, the resulted multiplication array tends to increment its circuit area by 3 times, i.e., every bit added in each multiplicator, three times increased the circuit area as compared to its original area, implying a linear increment tendency in the circuit area of the multiplication array, and thus a linear increased response latency thereof. Further, when the bit number of the multiplicators increases as twice over its original number, the response latency only increases slightly. It demonstrates the successful of the design provided by this invention. Although the increasing tendency of the whole area of the Galois field multiplier is O(m²), i.e., GF(64) tends to 4 times as large as GF(32), GF(128) is 4 times as large as GF(64), and so on, the response latency will increase linearly.

TABLE 1
Parameters of the Galois field multiplier and
its multiplication array of this invention

| | area (^{μm × μm}) | Response time (ns) |
|---|---|---|
| multiplication array | | |
| GF(256)_array | 299731 | 5.12 |
| GF(128) _array | 96997 | 4.27 |
| GF(64) _array | 30899 | 3.4 |
| GF(32) _array | 9597 | 2.71 |
| GF(16) _array | 2856 | 2.01 |
| multiplier | | |
| GF(256) | 1459890 | 5.6 |
| GF(128) | 480145 | 4.8 |
| GF(64) | 161437 | 3.74 |
| GF(32) | 37700 | 2.63 |

While some example embodiments have been described with reference to the drawings, it should be understood that this invention is not to be restricted to those exact embodiments. Many modifications and variations are apparent to those skilled without departing from the scope and spirit of this invention. All of those modifications and variations are intended to be comprised in the scope of this invention as defined in the appended claims.

1. A Galois field multiplier, comprising:
a multiplication circuit for inputting two m bits binary multipicators and outputting their product, wherein m is an integral power of 2, and the output of said multiplication circuit is consisted of a high bits portion output and a low bits portion output;
a memory for storing a Galois field multiplication coefficient array calculated from a selected Galois field primitive polynomial;
a first module for performing operation on the output of said multiplication circuit and the Galois field multiplication coefficient array stored in said memory to obtain the product of said two m bits binary multipicators over Galois field.

2. The Galois field multiplier according to claim 1, wherein the operation performed by said first module comprises:
performing AND operation on each bit of the high bits portion of the output of said multiplication circuit and the corresponding multiplication coefficient in the Galois field multiplication coefficient array stored in said memory, thereafter, performing XOR operation on all of the results of the AND operation, and then performing XOR operation on the results of said XOR operation and the low bits portion of the output of said multiplication circuit to obtain the product of the two multiplicators over Galois field.

3. The Galois field multiplier according to claim 2, wherein the first module comprises a plurality of AND gates divided into at least m AND gates groups, each AND gates group having at least m AND gates, wherein each AND gates group is engaged in the bitwise AND operation on one coefficient of the Galois field multiplication coefficient array and the high bits portion of the output of said multiplication circuit.

4. The Galois field multiplier according to claim 3, wherein the first module further comprises a plurality of XOR gates divided into two groups, each group having at least m XOR gates, wherein one of m XOR gates of the first group takes the corresponding output bits of each said AND gates group as input, outputs the result of XOR operation for the corresponding bits of each said AND gates group, and each gate of m XOR gates of the second group is used to perform XOR operation on each output of the first XOR gates group and a corresponding bits of the low bits portion of the output of said multiplication circuit, and output each bit of the result of Galois field multiplication.

5. The Galois field multiplier according to any of claims 2-4, wherein said multiplication circuit comprises a first multiplier, a second multiplier, a second module, a third XOR gates group and a third module, wherein:
the first multiplier is operable to receive the low bits portions of the two m bits binary multiplicators to be multiplied over Galois field, and outputs a low bits product signal thereof;
the second multiplier is operable to receive the high bits portions of the two m bits binary multiplicators to be multiplied over Galois field, and outputs a high bits product signal thereof;
the second module is operable to receive the low bits portions and the high bits portions of the two m bits binary multiplicators to be multiplied over Galois field, then perform XOR operation on the low bits portions and the high bits portions of the two multiplicators to be multiplied over Galois field respectively, and perform multiply operation on the results of the XOR operation to output a bits mixed product signal;
the third XOR gates group is operable to perform XOR operation on the bits mixed product signal, the low bits product signal and the high bits product signal, then output a mixed XOR signal; and
the third module is operable to receive the low bits product signal, the high bits product signal and the mixed XOR signal, left shift the high bits product signal by m bits, left shift the mixed XOR signal by m/2 bits respectively, and then perform XOR operation on the high bits product signal left shifted by m bits, the mixed XOR signal left shifted by m/2 bits, and the low bits product signal to output the product of the two multiplicators.

6. The Galois field multiplier according to claim 5, wherein the second module comprises:
a first XOR gate for receiving the low bits portions of the two m bits binary multiplicators to be multiplied over Galois field and outputting a XOR value thereof;
a second XOR gate for receiving the high bits portions of the two m bits binary multiplicators to be multiplied over Galois field and outputting a XOR value thereof;
a third multiplier for receiving the outputs of the first and second XOR gates, and outputting a bits mixed product signal through multiplying the outputs of the first and second XOR gates.

7. The Galois field multiplier according to claim 5 or 6, wherein the third module comprises:
two shift registers, the first shift register is used for left shifting the high bits product signal by m bits, and the second shift register is used for left shifting the bits mixed product signal by m/2 bits; and
a fourth XOR gates group for performing XOR operation the output of said first shift register, the output of dais second shift register and the output of the first multiplier to obtain the product of the two multiplicators.

8. The Galois field multiplier according to claim 7, wherein the fourth XOR gates group of the third module is formed by at least m-2 XOR gates, wherein m/2-1 XOR gates are adopted in performing XOR operation on the high bits portion of the mixed XOR signal and the low bits portion of the high bits product signal, the other m/2-1 XOR gates are adopted in performing XOR operation on the low bits portion of the mixed XOR signal and the high bits portion of the low bits product signal.

9. The Galois field multiplier according to claim 8, wherein the output of the fourth XOR gates group of said third module is consisted of a highest part, a higher part, a mid part, a lower part and a lowest part, wherein except for the 1 bit mid part, each of the other parts is consisted of a plurality of bits, the highest part corresponding to the m-2 to m/2-1 bits of said high bits product signal; the higher part corresponding to the output of bitwise AND operation on the m−2 to m/2 bits of said mixed XOR signal and the m/2-2 to 0 bits of said high bits product signal; the mid part corresponding to the m/2-1 bit of said mixed XOR signal; the lower part corresponding to the output of bitwise AND operation on the m/2-2 to 0 bits of said mixed XOR signal and the m-2 to m/2 bits of said low bits product signal; and the lowest part corresponding to the m/2-1 to 0 bits of the low bits product signal.

10. The Galois field multiplier according to claim 1 or 2, wherein said memory for storing the Galois field multiplication coefficient array calculated from the selected Galois field primitive polynomial is implemented as a shift register, which calculates and stores the Galois field multiplication coefficient array.

11. The Galois field multiplier according to claim 1 or 2, wherein said memory for storing the Galois field multiplication coefficient array calculated from the selected Galois field primitive polynomial calculates the Galois field multiplication coefficient array previously, and then is implemented as a memory array.
